(19) United States
(12) Patent Application Publication
(10) Pub. No.: US 2001/0022584 A1
(43) Pub. Date: Sep. 20, 2001

(54) PORTABLE INFORMATION PROCESSING UNIT

(76) Inventor: SHUICHI TSUGAWA, KYOTO-SHI (JP)

Correspondence Address: NIXON & VANDERHYE, 1100 NORTH GLEBE ROAD, 8TH FLOOR, ARLINGTON, VA, 222014714

(21) Appl. No.: 09/181,918

(22) Filed: Oct. 29, 1998

(30) Foreign Application Priority Data
Nov. 12, 1997 (JP) 329427/1997

(51) Int. Cl. G09G 3/36

(52) U.S. Cl. 345/211; 345/87

(57) ABSTRACT

When a first group of contacts 31a is selected by a power switch 30, all power supply is stopped, when a second group of contacts 31b is selected, power from a power supply portion 27 is supplied only to an information processing circuit 20 and an LCD drive circuit 24, and when a third group of contacts 31c is selected, power from a power supply portion 27 is supplied to all of the information processing circuit 20, the LCD drive circuit 24 and a backlight emitter 26. Thus, an user can arbitrarily choose between turning on a backlight to obtain a bright and legible screen or seeing the screen through natural reflection light with turning off the backlight.

### BACKGROUND OF THE INVENTION

1. Field of the Invention

The present invention relates to portable information processing units, and more particularly to a portable information processing unit with a liquid crystal display, for example, a portable game machine and a portable information-gathering unit.

2. Description of the Background Art

A portable information processing unit is powered through a battery, therefore, a conventional display provided therein is generally a liquid crystal display consuming the small amount of power. It is known that the crystal liquid display requires a light source for displaying an image since it does not emit light by itself. Such light source includes a backlight source and a reflection light source. The back light source is placed on a back surface of the liquid crystal display. A user sees light passing from the backlight source through the liquid crystal display. As for the reflection light source, extraneous light is passed through the liquid crystal display and reflected on the back surface thereof to be used as a source of light. Therefore, on the back surface of the liquid crystal display is attached a reflection plate.

Conventionally, a portable information processing unit with a liquid crystal display includes a unit using a black-and-white liquid crystal display and a unit using a color liquid crystal display. The black-and-white liquid crystal display can display a legible image with the relatively small quantity of light; the color liquid crystal display, on the contrary, requires the larger quantity of light for displaying a legible image in order to display the image in color.

Accordingly, the information processing unit with the black-and-white liquid crystal display is generally a unit utilizing only reflection of extraneous light without the aid of a backlight source, such as a portable electronic game machine marketed by the present applicant (under the trade name of “GAME BOY”). In such information processing unit, a total reflective-type reflection plate is attached to the back surface of the black-and-white liquid crystal display.

On the other hand, the information processing unit with the color liquid crystal display generally uses a backlight source. In such information processing unit, a transmissive-type reflection plate is provided between the color liquid crystal display and the backlight source.

As described in the above, the conventional portable information processing unit with the black-and-white liquid crystal display uses the total-reflective-type reflection plate, therefore cannot use a backlight source even if consuming the large amount of power. By replacing the total-reflective-type reflection plate with a transmissive-type reflection plate, it is possible to provide a backlight source in the information processing unit. In this case, however, when the battery becomes exhausted to drop in voltage, light from the backlight source cannot be supplied to the information processing unit, where a legible screen cannot be obtained. As a result, it is impossible to use the information processing unit.

On the other hand, the portable information processing unit with the color liquid crystal display using the transmissive-type reflection plate has a problem that when the battery voltage drops, it cannot turn on the backlight source. Therefore, it can hardly display a legible image and as a result cannot be used at all. Besides, even when used in a light place where the backlight source is not needed, the information processing unit has to be used with the backlight emitting light, thereby shortening the battery life.

### SUMMARY OF THE INVENTION

Accordingly, an object of the present invention is to provide a portable information processing unit capable of always displaying a clear image regardless of environment and keeping its battery life longer.

The present invention has the following characteristics to achieve the object above.

A first aspect of the present invention is directed to a portable information processing unit to be used by a storage medium storing at least program data being connected thereto, comprising:

an information processing circuit for performing data processing based on the program data stored in the storage medium;

a liquid crystal display for displaying data processed by the information processing circuit;

a transflective-type reflection plate laminated on a back surface of the liquid crystal display;

a backlight emitter, in a shape of a sheet, having the same flat form as the liquid crystal display and laminated on a back surface of the transflective-type reflection plate;

a backlight drive circuit for driving the backlight emitter;

a power supply portion for supplying power; and

a power switch capable of being switched among a first group of contacts, a second group of contacts and a third group of contacts,

the power switch:

stopping all power supply when the first group of contacts is selected;

supplying power from the power supply portion only to the information processing circuit and the liquid crystal display when the second group of contacts is selected; and

supplying power from the power supply portion to all of the information processing circuit, the liquid crystal display, and the backlight drive circuit when the third group of contacts is selected.

As described in the foregoing, in the first aspect, the information processing unit can be used with turning off the backlight emitter since it has the transflective-type reflection plate as a reflection plate. Therefore, it is possible for a user to arbitrarily select whether to see a bright screen with the backlight emitter turned on or to look at a screen through natural reflection light with turning off the backlight emitter. Thus, the information processing unit can be used with turning off the backlight when used in a light place, making it possible to prevent undesired power consumption. Moreover, the information processing unit can be used with a bright screen by turning on the backlight as required when used in a dark place. Furthermore, in the first aspect, the power of the information processing unit body and the backlight emitter is turned on/off with one switch, which simplifies the structure of the switch portion to be easily operated by the user.

According to a second aspect of the present invention, in the portable information processing unit of the first aspect,

the transflective-type reflection plate is made of a material in which reflectance is higher than transmittance.

The portable information processing unit according to the present invention is used in a light place in most cases rather than in a dark place. Therefore, in the above second aspect, the reflectance is given higher priority than the transmittance, to put emphasis on use without the backlight source. Generally, in the case where the reflectance is lowered excessively, the display screen is degraded in viewability when the backlight emitter is turned off. The information processing unit of the present invention solves the above problem by having the backlight emitter laminated directly on the back surface of the liquid crystal display. In this way, the sufficient quantity of transmitted light can be acquired, which prevents the viewability from being degraded.

According to a third aspect of the present invention, in the portable information processing unit of the first aspect,

the backlight drive circuit includes a power converting circuit for converting a DC power supplied by the power supply portion into an AC power of a voltage and a frequency suitable for driving the backlight emitter.

As described in the foregoing, in the third aspect, the backlight drive circuit includes the power converting circuit, making it possible to properly drive the backlight emitter even when an electroluminescent display is used as the backlight emitter, for example.

According to a fourth aspect of the present invention, the portable information processing unit of the first aspect further comprises:

a power-supply-voltage detecting circuit for detecting whether a voltage of the power supply portion is more than or equal to a given value; and

a backlight-drive control circuit for controlling the backlight drive circuit based on a result detected by the power-supply-voltage detecting circuit, and

in the portable information processing unit,

the backlight-drive control circuit places the backlight drive circuit in its inactive state in response to the result detected by the power-supply-voltage detecting circuit that the voltage of the power supply portion is less than the given value, and thereby stops power supply to the backlight emitter.

As stated above, according to the fourth aspect, when the voltage of the power supply portion drops to be less than the given value, the power supply to the backlight emitter is stopped. This minimizes the power consumption and enables the use of the information processing unit to be continued utilizing reflection light without the aid of the backlight source.

According to a fifth aspect of the present invention, the portable information processing unit of the first aspect further comprises:

an intensity control portion for controlling intensity of the backlight emitter; and

a voltage adjusting portion connected in relation to the third group of contacts of the power switch, for adjusting a voltage value in an analog fashion, and

in the portable information processing unit,

the intensity control portion adjusts the intensity of the backlight emitter based on a position of the voltage adjusting portion.

As stated above, in the fifth aspect, the intensity of the backlight emitter is adjustable, allowing adjustment of the power consumption at the time of using the backlight emitter.

According to a sixth aspect, in the portable information processing unit of the first aspect,

the power switch is a three-position switch capable of being switched among a first position for selecting the first group of contacts, a second position for selecting the second group of contacts, and a third position for selecting the third group of contacts.

According to a seventh aspect, in the portable information processing unit of the first aspect,

the power switch is a two-position switch with a pushbutton having a first position for selecting the first group of contacts and a second position for selecting the second group of contacts, and selecting the third group of contacts when the pushbutton is pushed at the second position.

Theses and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view showing the configuration of a portable information processing unit with a liquid crystal display according to an embodiment of the present invention;

FIG. 2 is a block diagram showing the electrical configuration of the information processing unit (a game machine body) according to the embodiment of the present invention;

FIG. 3 is a diagram showing the lamination structure of an LCD, a transflective reflection plate and a backlight emitter;

FIG. 4 is a diagram showing the mechanism of a three-position switch as an example of a power switch;

FIG. 5 is a diagram showing a circuit of a DC-DC converter in detail;

FIG. 6 is a diagram showing a circuit of a backlight drive circuit in detail;

FIG. 7 is a block diagram showing the configuration of a portable information processing unit according to another embodiment of the present invention;

FIG. 8 is a block diagram showing the configuration of a portable information processing unit according to still another embodiment of the present invention; and

FIG. 9 is a block diagram showing the configuration of a portable information processing unit according to a further embodiment of the present invention.

### DESCRIPTION OF THE PREFERRED EMBODIMENTS

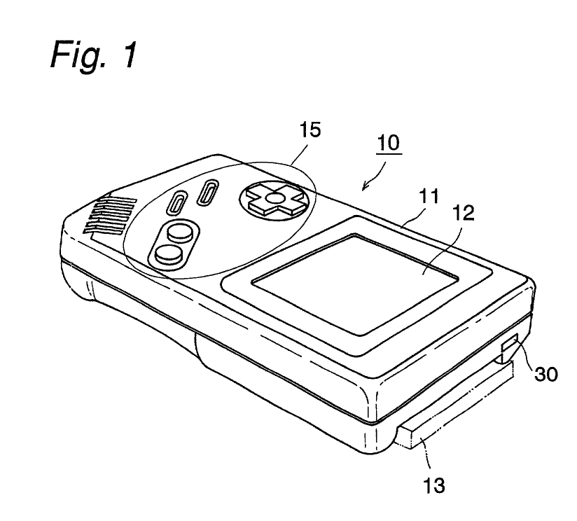

FIG. 1 is an external view showing the configuration of a portable information processing unit with a liquid crystal display according to an embodiment of the present invention. Described below is a case where a portable information processing unit 10 is applied to a portable game machine. The portable information processing unit 10 of the present invention can be applied to a portable information-gathering unit for readily gathering sales data in a shop, a portable ticket dispenser used in a train, and the like. Since described below is the case of applying the portable information processing unit 10 to the game machine, the portable information processing unit 10 is referred to as a game machine body.

The game machine body 10 includes a housing 11. On the main surface (the front surface) of the housing 11 is provided a liquid crystal display 12 (hereinafter, referred to as “LCD”) capable of dot-matrix display.

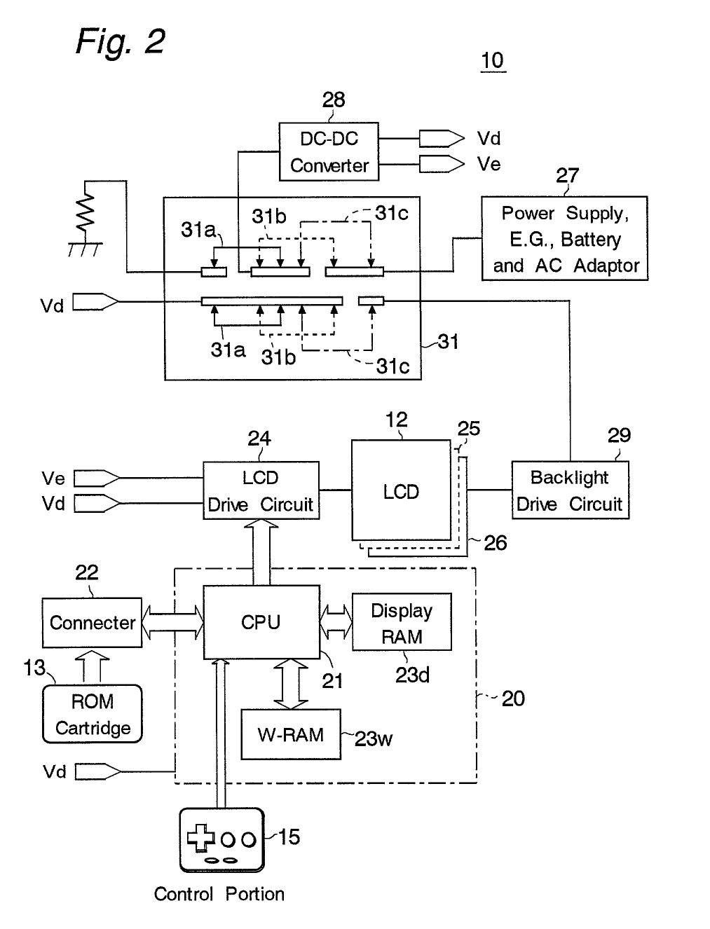

On the upper portion of the back surface of the game machine body 10 is provided an insertion (not shown). To the insertion is detachably attached a ROM cartridge 13. In the ROM cartridge 13 is contained, for example, ROM as one of nonvolatile memory (such as mask ROM, EP-ROM). ROM stores image data and program data for image processing for a game and the like, and also stores audio data such as music and sound effect as required. Moreover, in the ROM cartridge 13 is contained writable and readable memory (RAM) for storing data such as scores generated in the course of a game, and acquired items as required. In place of the ROM cartridge 13, a CD-ROM, a magnetic disk, and the like may be used. After the ROM cartridge 13 is attached to the game machine body 10, a game program is executed by an internal CPU (a CPU 21 shown in FIG. 2 described later). Then, an image for the game is displayed on the LCD 12. At a position lower than the LCD 12 on the main surface of the housing 11 is provided a control portion 15 including control switches for giving instructions about the behavior of a game character displayed on the LCD 12. On the top side-surface of the housing 11 is provided a power switch 30 for supplying power to the game machine body 10.

FIG. 2 is a block diagram showing the electrical configuration of the information processing unit (the game machine body) according to the embodiment of the present invention. In FIG. 2, the game machine body 10 includes a CPU 21. To the CPU 21 is connected a connector 22 for detachably attaching the ROM cartridge 13 to the game machine body 10, and working RAM 23w and display RAM 23d as well. Working RAM 23w is memory for temporarily storing data processed by the CPU 21. Display RAM 23d rewrites dot data to be displayed on the LCD 12 for each frame and temporarily stores the result. The CPU 21 performs processing based on a program in response to the input from the control portion 15, then generates display data for varying the display state of the LCD 12, and writes the data in display RAM 23d. The display data stored in display RAM 23d is supplied through an LCD drive circuit 24 to the LCD 12 and displayed thereon. The CPU 21, working RAM 23w and display RAM 23d form an information processing circuit 20.

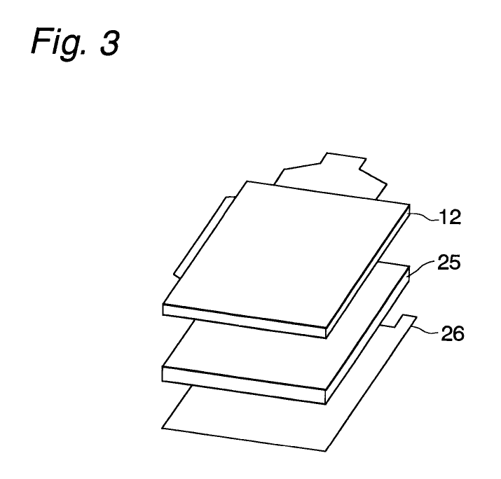

Next, referring to FIGS. 2 and 3, described in detail are the LCD 12, a transflective-type (having both transmissive and reflective properties) reflection plate 25 and a backlight emitter 26. As shown in FIG. 3, the transflective-type (hereinafter, also referred to as “transflective”) reflection plate 25 and the backlight emitter 26 are laminated on the back surface of the LCD 12. The lamination is made by pasting the transflective reflection plate 25 on the back surface of the LCD 12 and then placing the backlight emitter 26 on the back surface of the transflective reflection plate 25. As the transflective reflection plate 25, a transflective-type reflection plate is used, which reflects extraneous light (natural light or illumination light) entered through the LCD 12 and also transmits the light emitted by the backlight emitter 26. Preferably, the transflective reflection plate 25 is made of a material in which the reflectance reflecting the extraneous light is higher than the transmittance transmitting the emitted light (lit light) from the backlight emitter 26 laminated on the back surface thereof. The reason for the above is that the portable information processing unit of the present embodiment is used in a light place in most cases and therefore gives priority to the reflectance. Moreover, there is a problem that when the reflectance is excessively lowered, the viewability of a display screen is degraded at the time of turning off the backlight emitter 26. In order to solve the problem, in the present embodiment, the backlight emitter 26 is laminated directly on the back surface of the LCD 12. Accordingly, when the transmittance is low to a degree, the sufficient quantity of transmitted light can be acquired, thereby preventing the viewability from being degraded.

For example, in the transflective reflection plate 25, if the reflectance is sixty percent, the transmittance becomes forty percent, whereas if the reflectance is ninety percent, the transmittance becomes ten percent. More preferably, the transflective reflection plate 25 is made of a material in which the reflectance is within the range of sixty percent to ninety percent, and the transmittance is within the range of ten percent to forty percent. An article to be marketed by the applicant as a final product uses the transflective reflection plate 25 in which the reflectance is ninety percent and the transmittance is ten percent. Besides, as the backlight emitter 26, used is an electroluminescent (EL) display which is sheet-like shaped similar to the LCD 12 and driven by high-frequency power with a frequency of 1 kilohertz and a voltage of approximately 60 volts.

In this way, the present embodiment uses a black-and-white liquid crystal display as the LCD 12 and the transflective reflection plate 25 of a reflection-emphasized type. Therefore, the present embodiment can be used with the backlight turned off and also provide a legible screen with the backlight emitting light or turned on even in the environment where the display screen is difficult to be seen (that is, in a dark place). Besides, the backlight emitter 26 is thin and sheet-like shaped similar to the LCD 12, thereby downsizing and sliming down the unit.

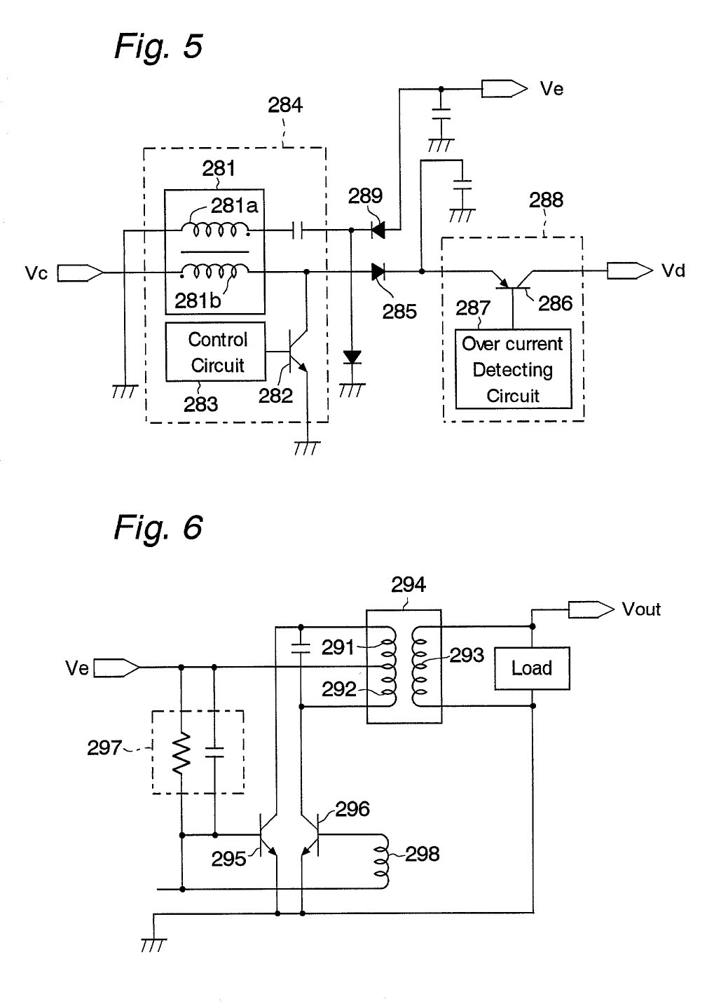

Next, a drive circuit for making the backlight emitter 26 emit (or light) is described in detail. The game machine body 10 further includes a power supply portion 27 such as a battery or an AC adapter, a DC-DC converter 28, a backlight drive circuit 29, and a power switch 30. The DC-DC converter 28 converts the power of the power supply portion 27 into a DC voltage suitable for being supplied to the information processing circuit 20, the LCD 12 and the backlight emitter 26. The backlight drive circuit 29 supplies the backlight emitter 26 with high-frequency power. The DC-DC converter 28 and the backlight drive circuit 29 will be described in detail later, referring to FIGS. 5 and 6. The power switch 30 selects a state of supplying power from the power supply portion 27.

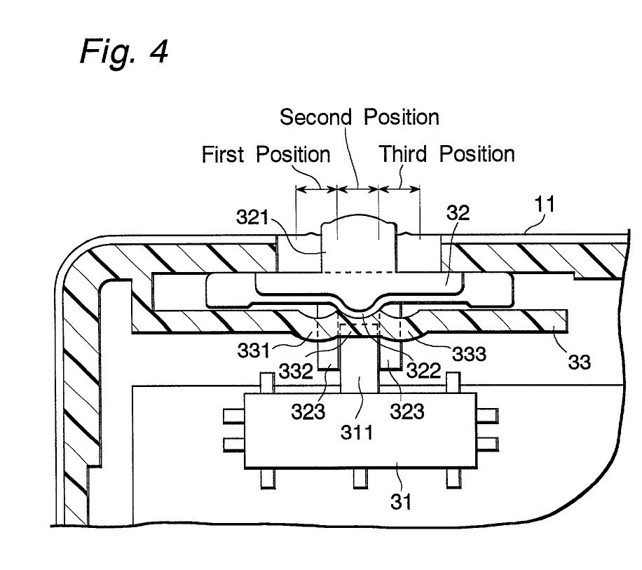

Specifically, the power switch 30 can be switched among three groups of contacts; a first group of contacts 31a, a second group of contacts 31b and a third group of contacts 31c (in each group of contacts, a plurality of contacts are connected to each other as shown in FIG. 2). As the power switch 30, a three-position switch is used capable of being switched among a first position, a second position and a third position. As shown in FIG. 4, the power switch 30 includes, for example, a slide portion 32 capable of sliding in a left and right (horizontal) direction over the housing 11, a guiding portion 33 for guiding movement of the slide portion 32, and a slide switch 31 capable of being switched among the first group of contacts 31a, the second group of contacts 31b and the third group of contacts 31c by the slide of the slide portion 32. The slide portion 32 forms a control protrusion 321 protruding from the center of the upper surface thereof, an engaging protrusion 322 at a part of the lower surface thereof, and an engaging protrusion 323 for being engaged with a sliding protrusion 311 of the slide switch 31. The guiding portion 33 has three depression portions 331, 332 and 333 along the direction the slide portion 32 moves, and locates the slide portion 32 at the position where the engaging protrusion 322 is engaged in any of the depression portions 331, 332 and 333, in a half-fixed state. Thus, the slide switch 31 is in a state of selecting any of the first group of contacts 31a, the second group of contacts 31b and the third group of contacts 31c. Then, the power switch 30 is switched so as to stop (turn off) all power supply when the slide portion 32 is located at the depression portion 331 to select the first group of contacts 31a, supply power from the DC-DC converter 28 only to the information processing circuit 20 and the LCD 12 when the slide portion 32 is located at the depression portion 332 to select the second group of contacts 31b, and supply power from the power supply portion 27 to all of the information processing circuit 20, the LCD 12 and the backlight drive circuit 29 when the slide portion 32 is located at the depression portion 333 to select the third group of contacts 31c.

Next, the specific operation is described. When the first position of the power switch 30 is selected to select the first group of contacts 31a, the power supply portion 27 and the DC-DC converter 28 are not connected to each other. That is to say, the power switch 30 is turned off and therefore no power is supplied to any circuits or components.

On the other hand, when the second position is selected to select the second group of contacts 31b (in other words, when two contacts are connected), the power supply portion 27 and the DC-DC converter 28 are connected to each other. Thereby, the voltage from the power supply portion 27 is converted (stepped up and stepped down) with the DC-DC converter 28 into two power voltages; Vd (for example, 5 volts) and Ve (for example, −18 volts), to be outputted. Therefore, the power of the power voltage Vd is supplied to the information processing circuit 20, and the power of a voltage equivalent to the difference in voltage between Vd and Ve is supplied to the LCD drive circuit 24. In this way, the information processing circuit 20 and the LCD 12 are activated. In this case, since the backlight drive circuit 29 and the power voltage Vd are not connected to each other, no power is supplied to the backlight drive circuit 29, and as a result, the backlight emitter 26 does not emit light. This case is for a light environment where the backlight source is not needed, therefore the major part of the extraneous light is reflected by the transflective reflection plate 25 to be seen by the user. Thus, it is possible for the user to obtain a legible display image without the emission by the backlight emitter 26 and also use the game machine body 10 with the power consumption thereof reduced.

Furthermore, when the third position is selected to select the third group of contacts 31c (that is, the two contacts are connected), the power supply portion 27 and the DC-DC converter 28 are connected to each other, and in addition, the DC-DC converter 28 and the backlight drive circuit 29 are connected to each other, and the DC voltage Vd is supplied to the backlight drive circuit 29. Therefore, the backlight drive circuit 29 converts the power voltage Vd into a high-frequency power (for example, 1 kilohertz) which is stepped up in voltage (for example, 60 volts), and supplies the same to the backlight emitter 26. Accordingly, in this state, the backlight emitter 26 is turned on to emit light. Thus, even when the game machine body 10 is used in a dark environment where the screen is difficult to be seen, a legible screen can be realized.

Next, the DC-DC converter 28 and the backlight drive circuit 29 used in the present embodiment are described in detail.

FIG. 5 is a diagram showing a circuit of the DC-DC converter 28 in detail. When the power switch 30 selects the second group of contacts 31b and/or the third group of contacts 31c, the power supply portion 27 and the DC-DC converter 28 are connected to each other, thereby a DC voltage (Vc=3 volts) from the power supply portion 27 is supplied to the DC-DC converter 28. The DC-DC converter 28 includes a step-up transformer 281, a parallel constant-voltage circuit 284 having a transistor 282 and a switching control circuit 283, a diode 285, a protective circuit 288 having a transistor 286 and an overcurrent detecting circuit 287, and a diode 289.

After the battery voltage Vc is applied to the DC-DC converter 28, derived from a coil 281a of the step-up transformer 281 is a voltage (−18 volts) which is reversed in polarity and multiplied by a factor of six. Then, the voltage stepped up to −18 volts is outputted as the power voltage Ve through the diode 289. Next, the DC voltage stepped up to 5 volts by the other coil 281b of the step-up transformer 281 is stabilized by the constant-voltage circuit 284, and outputted as the power voltage Vd through the diode 285 and the transistor 286.

In the case where an overcurrent is passed due to a problem such as a short-circuit in the circuit, the overcurrent detecting circuit 287 forcefully turns off the transistor 286, to stop the output of the power voltage Vd, thereby protecting the circuit.

FIG. 6 is a diagram showing a circuit of the backlight drive circuit 29 in detail. The backlight drive circuit 29 is an inverter performing DC-AC power conversion and converts a DC voltage into an AC voltage of a high-frequency and a high-voltage (1 kilohertz and 60 volts). Specifically, the backlight drive circuit 29 includes a transformer 294 formed of a primary coil 291, a primary coil 292 and a secondary coil 293, transistors 295 and 296, and a time-constant circuit 297 composed of a resistor and a capacitor. In the transformer 294, the numbers of windings of the primary coils 291 and 292 are the same, and the numbers of windings of the secondary coil 293 is sufficiently larger than the primary coils 291 and 292.

When the power voltage Vd is supplied to the backlight drive circuit 29, an on-off cycle of the switching transistor 295 is controlled according to a time constant of the time-constant circuit 297, and an on-off cycle of the transistor 296 is controlled according to an inductance of the coil 298 at a later timing than the transistor 295. By these control, the transistor 295 and the transistor 296 alternately repeats on-off operation, thereby a current passes through the primary coils 291 and 292 by turns. As a result, a stepped-up AC is induced in the secondary coil 293 to pass a high-frequency generating current, and for example, a power of 1 kilohertz and 60 volts is outputted from the both ends of the secondary coil 293.

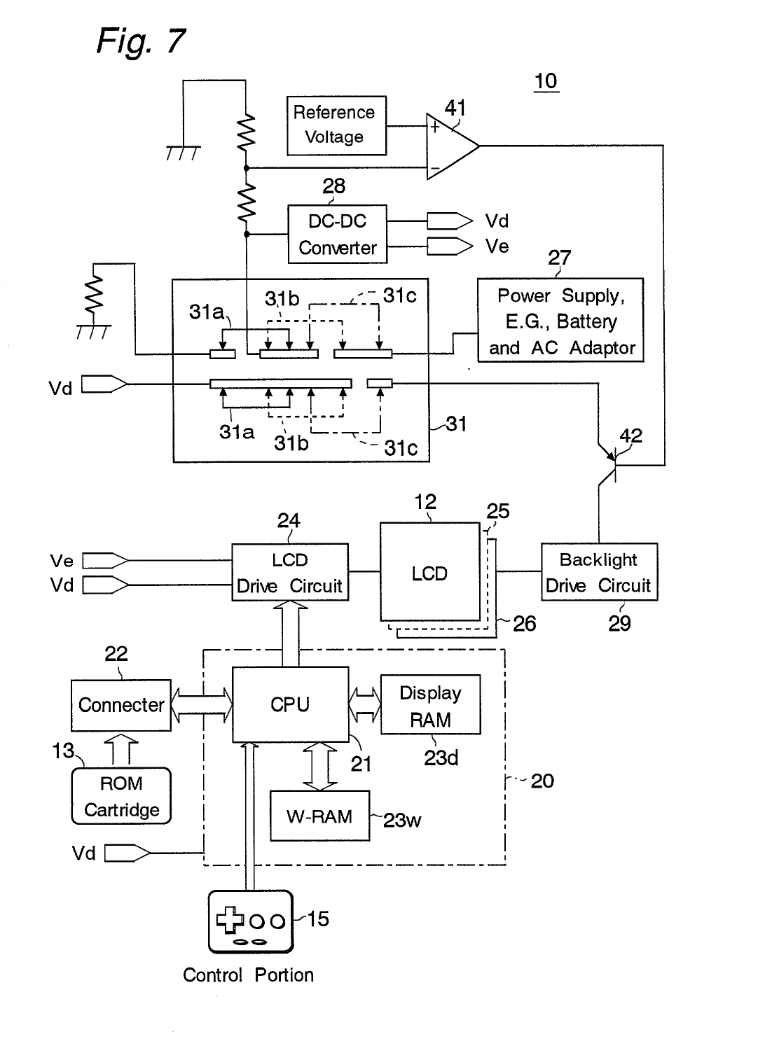

FIG. 7 is a block diagram showing the configuration of a portable information processing unit according to another embodiment of the present invention. FIG. 7 differs from the embodiment of FIG. 2 in that a comparator 41 for comparing a voltage value of the power supply portion 27 with a reference voltage value, and a transistor switch 42 are included, and when the battery voltage drops, the fact is automatically detected and the backlight drive circuit 29 is put in the inactive state.

That is to say, when the comparator 41 compares the battery voltage of the power supply portion 27 with the reference voltage value and detects that the battery voltage is lower than the reference voltage value, the transistor 42 is forcefully turned off and thereby the power supply to the backlight drive circuit 29 is stopped. Thus, in the state where the third group of contacts 31c is selected by the power switch 30, when the battery voltage drops below the reference voltage value, the power supply to the backlight emitter 26 is stopped to minimize the power consumption. This allows the game to be played utilizing reflection light without the aid of the backlight source.

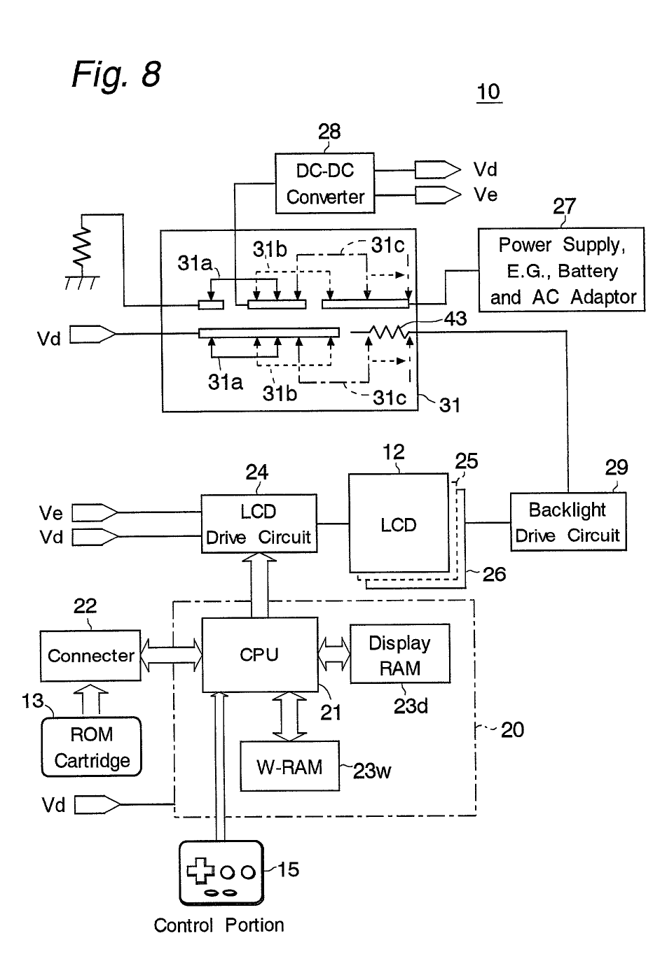

FIG. 8 is a block diagram showing the configuration of a portable information processing unit according to still another embodiment of the present invention. In the embodiment of FIG. 8, a variable resistor 43 is further provided for adjusting the voltage value in relation to the third group of contacts 31c of the power switch 30 in the embodiment of FIG. 2. By controlling the variable resistor 43 to adjust a resistance value, it is possible to adjust the intensity of the backlight emitter 26. Accordingly, the variable resistor 43 functions as means for adjusting the intensity (or lightness) of the backlight emitter 26, or means for adjusting the brightness of a display which is a combination of the LCD 12 and the backlight emitter 26 in one.

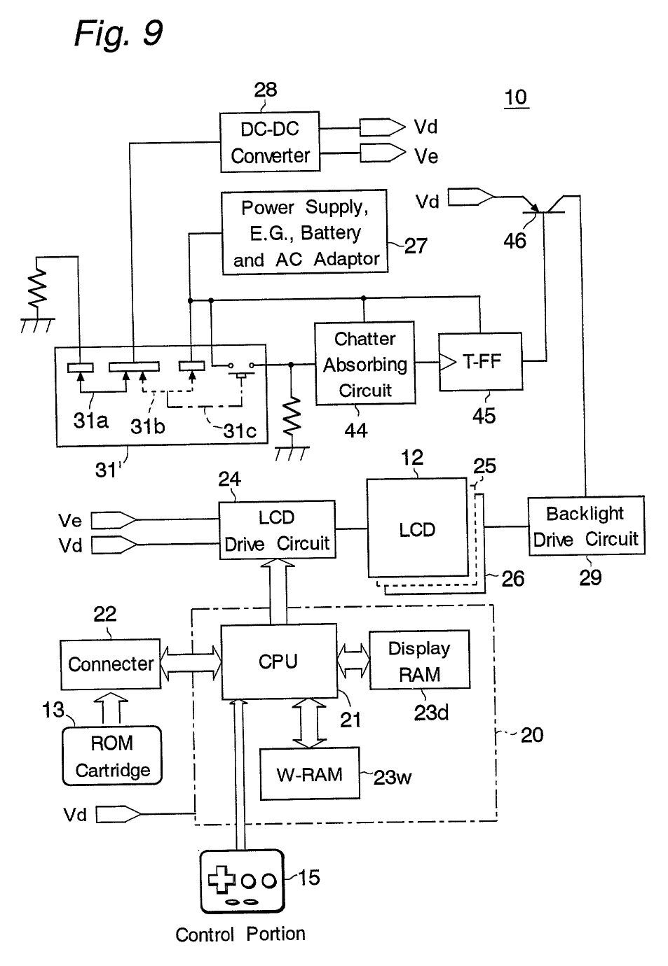

FIG. 9 is a block diagram showing the configuration of a portable information processing unit according to a further embodiment of the present invention. In the embodiment of FIG. 9, a two-position switch 31′ is used in place of the three-position slide switch 31 used in the embodiment of FIG. 2. The two-position switch 31′ is a switch with a pushbutton capable of selecting the third group of contacts 31c by being pushed at the second position.

In the embodiment of FIG. 9, the switch 31′ has a first position for selecting the first group of contacts 31a and a second position for selecting the second group of contacts 31b, and is configured so as to select the third group of contacts 31c in response that the pushbutton is pushed at the second position. Besides, a chatter absorbing circuit 44 is provided in relation to the third group of contacts 31c, and a T flip-flop 45 and a transistor 46 operating according to the chatter absorbing circuit 44 are provided.

When the pushbutton of the switch 31′ is pushed to select the third group of contacts 31c, the voltage from the power supply portion 27 is temporality inputted to the chatter absorbing circuit 44, allowing the input to the T flip-flop 45 to rise. In response to this, the T flip-flop 45 inverts its Q output, to output a signal at high level. Correspondingly, the transistor 46 is turned on and supplies the power voltage Vd to the backlight drive circuit 29, thereby the backlight emitter 26 emits light.

When the pushbutton of the switch 31′ is pushed, the input to the T flip-flop 45 rises and the Q output is inverted. Thereby, the transistor 46 is in the off state and the power supply to the backlight drive circuit 29 is stopped. In the above way, every time the pushbutton is pushed, the backlight emitter 26 is turned on/off.

While the invention has been described in detail, the foregoing description is in all aspects illustrative and not restrictive. It is understood that numerous other modifications and variations can be devised without departing from the scope of the invention.

What is claimed is:

1. A portable information processing unit to be used by a storage medium storing at least program data being connected thereto, comprising:
an information processing circuit for performing data processing based on the program data stored in said storage medium;
a liquid crystal display for displaying data processed by said information processing circuit;
a transflective-type reflection plate laminated on a back surface of said liquid crystal display;
a backlight emitter, in a shape of a sheet, having the same flat form as said liquid crystal display and laminated on a back surface of said transflective-type reflection plate;
backlight drive means for driving said backlight emitter;
a power supply portion for supplying power; and
a power switch capable of being switched among a first group of contacts, a second group of contacts and a third group of contacts,
said power switch:
stopping all power supply when said first group of contacts is selected;
supplying power from said power supply portion only to said information processing circuit and said liquid crystal display when said second group of contacts is selected; and
supplying power from said power supply portion to all of said information processing circuit, said liquid crystal display, and said backlight drive means when said third group of contacts is selected.

2. The portable information processing unit according to claim 1, wherein said transflective-type reflection plate is made of a material in which reflectance is higher than transmittance.

3. The portable information processing unit according to claim 1, wherein said backlight drive means includes power converting means for converting a DC power supplied by said power supply portion into an AC power of a voltage and a frequency suitable for driving said backlight emitter.

4. The portable information processing unit according to claim 1, further comprising:
power-supply-voltage detecting means for detecting whether a voltage of said power supply portion is more than or equal to a given value; and
backlight-drive control means for controlling said backlight drive means based on a result detected by said power-supply-voltage detecting means, and
wherein said backlight-drive control means places said backlight drive means in an inactive state in response to the result detected by said power-supply-voltage detecting means that the voltage of said power supply portion is less than the given value, and thereby stops power supply to said backlight emitter.

5. The portable information processing unit according to claim 1, further comprising:
intensity control means for controlling intensity of said backlight emitter; and
voltage adjusting means connected in relation to said third group of contacts of said power switch, for adjusting a voltage value in an analog fashion, and
wherein said intensity control means adjusts the intensity of said backlight emitter based on a position of said voltage adjusting means.

6. The portable information processing unit according to claim 1, wherein said power switch is a three-position switch capable of being switched among a first position for selecting said first group of contacts, a second position for selecting said second group of contacts, and a third position for selecting said third group of contacts.

7. The portable information processing unit according to claim 1, wherein said power switch is a two-position switch with a pushbutton having a first position for selecting said first group of contacts and a second position for selecting said second group of contacts, and selecting said third group of contacts when the pushbutton is pushed at the second position.
